(19) United States
(12) Patent Application Publication
(10) Pub. No.: US 2016/0180724 A1
(43) Pub. Date: Jun. 23, 2016

(54) Customized Online Media Segment Sequencing

(71) Applicant: James Robert Frith, JR., Black Mountain, NC (US)

(72) Inventor: James Robert Frith, JR., Black Mountain, NC (US)

(21) Appl. No.: 14/975,765

(22) Filed: Dec. 19, 2015

Related U.S. Application Data
(60) Provisional application No. 62/094,967, filed on Dec. 20, 2014.

(51) Int. Cl. G09B 5/02

(52) U.S. Cl. CPC G09B 5/02

(57) ABSTRACT

a system for organizing, storing, selecting, retrieving and delivering media segments, including a highly interactive feedback loop for the gathering of information from and delivery of information to a user, including a multimedia library that may store video segments, audio clips, slides, text messages, and other media; a screening module that may elicit, organize and store data from a user into a modifiable database; an assembler module for accessing and selecting the media stored in the multimedia library module based on the data stored in the screening module; a delivery module that may display to the user media selected by the assembler module and that receives feedback information from the user, and uses the feedback to modify an instructional sequence; and a calendar module that maintains a schedule of instructional sequences for the user.

### CROSS-REFERENCE TO RELATED APPLICATIONS

This application claims the benefit of U.S. Provisional Application Ser. No. 62/094,967, filed on Dec. 20, 2014, by the present inventor, entitled “Customized Online Digital Media Segment Sequencing,” which is hereby incorporated by reference in its entirety for all allowable purposes, including the incorporation and preservation of any and all rights to patentable subject matter of the inventor, such as features, elements, processes and process steps, and improvements that may supplement or relate to the subject matter described herein.

### BACKGROUND OF THE INVENTION

1. Field of the Invention

Embodiments of the present disclosure generally relate to systems for customized online media segment sequencing.

2. Description of the Related Art

When a user needs detailed, individually tailored instruction on a complex and specialized subject, they often consult an expert and pay a large price for the dedicated time from that expert. Instructional videos and digital media offer a cost-effective alternative, but the sheer numbers of potential users, each having many individual variables, render it impractical to produce a single, uniform instructional video in any particular subject that would perfectly apply to a broad spectrum of the population. Even if there is a critical mass of information that may apply to a broad market, users who require different or tailored answers, or timely corrections or adjustments, are left unserved. Even the needs of individual users vary over time as understanding and skills develop or change.

This challenge applies to instruction in many subject areas. Particularly when a subject area requires highly specialized guidance or instruction, or where instruction or guidance will be delivered repeatedly in multiple variations to the same user, reliance on generally applicable video instruction has limited utility. Similarly, search engines and menu driven platforms offer limited utility because they require the user to direct the user's own instruction.

Therefore, there is a need for cost effective delivery of online instructional videos and other media that fit very specific needs of individual clients without including extraneous materials.

### SUMMARY OF THE INVENTION

Embodiments described herein generally relate to a system for organizing, storing, selecting, retrieving and delivering media segments, including a highly interactive feedback loop for the gathering and delivery of information to the user. More particularly, the embodiments described herein relate to a multimedia library that stores video segments, audio clips, slides, text messages, and other media; a screening module that elicits, organizes and stores data from a user into a modifiable database; an assembler module for accessing and selecting the media stored in the multimedia library based on the data stored in the screening module; a delivery module that displays to the user media selected by the assembler module and that receives feedback information from the user; and a calendar module that directs the screening module to point the assembler module to designated instructional sequences.

The integrated system of modules enables a user to view a personalized program of sequenced video segments selected based on user-provided data. This interactivity and corresponding automated adjustment to the lesson being taught provide a highly tailored learning/workout/problem solving experience similar to what would come from a human tutor, consultant, or dedicated advisor. This is far superior to search engines, or various online information providers available today, which can only give simple answers to simple questions or links to potential resources for user driven research. The system 1) builds a multimedia library specifically to fit into a custom designed structure of a potentially vast number of instructional sequences, on a specific complex topic, and of which may be highly tailored for each specific user, then 2) responds to user specific data and feedback that drive an algorithm to deliver relevant media segments at appropriate times in each instructional sequence, and 3) interacts with the user before, during and after each instructional sequence to effect an ongoing dialog exchange between the virtual expert/instructor and the user.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram depicting one embodiment of an exemplary video segment sequencing system according to embodiments described herein.

FIG. 2 is a wireframe depicting one embodiment of a user interface provided via a Screening Module according to embodiments described herein.

FIG. 3 is a wireframe depicting one embodiment of a user interface provided via a Delivery Module according to embodiments described herein.

FIG. 4 is a flow diagram for an exemplary video sequencing implementation process according to embodiments described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments described herein generally relate to systems for organizing, storing, selecting, retrieving and delivering video and other media segments. More particularly, the embodiments described herein provide a system of integrated modules that together provide a customized, feedback-integrated instructional video program.

In an exemplary embodiment, the video segment sequencing system provides integrated instructional media for use in physical fitness.

In another exemplary embodiment, the video segment sequencing system provides integrated instructional media for use in medical or biomechanical impairment diagnosis.

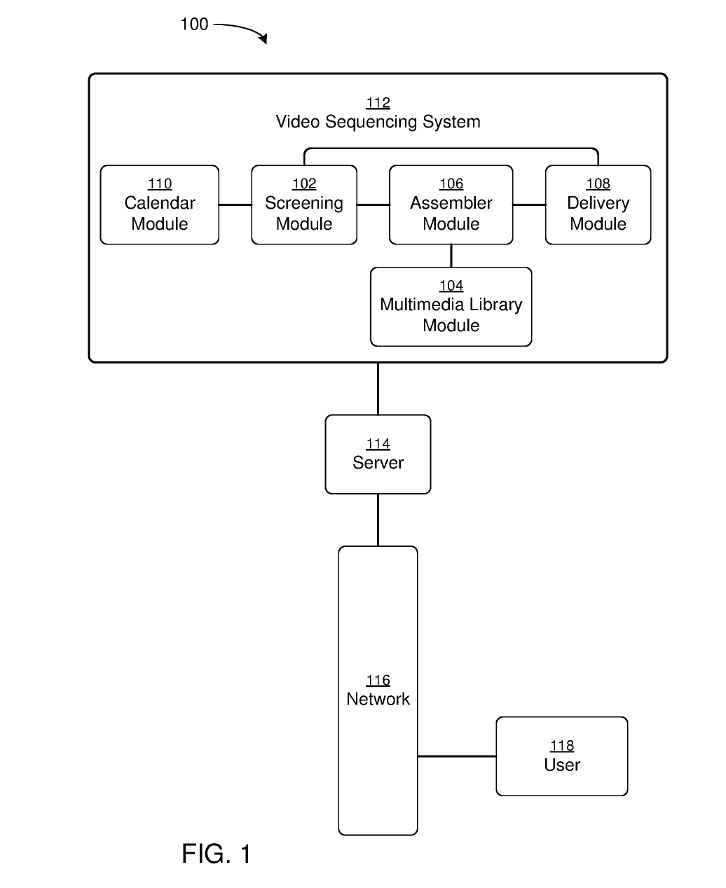

FIG. 1 is a block diagram 100 illustrating an exemplary embodiment of a video segment sequencing system 112. The user 118 interacts with the system 112 via a network 116 and a server 114. The network 116 may be a suitable interconnected communication environment, such as the Internet. The user 118 may access the network by personal computing devices, such as cell phones, electronic tablets, laptops, desktops, smart TVs, and etcetera, and the exemplary video sequencing system 112 may access the network 116 via the server 114.

The exemplary video sequencing system 112 manages and manipulates the experience of the user 118. The Screening Module 102 collects data and information from the user and from the Calendar Module 110 and may also collect data from other sources, for example movement sensors. The Screening Module 102 is programmed with features, such as diagnostic tests, prompts and profile data fields, which drive the gathering of information from the client to lead to specifically dictated responses for the specific situations. The user 118 answers questions designed to elicit very specific data of the user's needs and wants. The collected data is stored in a database in the Screening Module 102. The user 118 may modify the user's data over time as the user's changing needs are communicated via the Screening Module 102 user interface or the Delivery Module 108 user interface. Topics, such as personal fitness guided workouts, require constant activity by the user during each instructional sequence. In such cases, the Delivery Module 108 may also incorporate an interactive preview page and an interactive summary page for each lesson/workout, which allows for additional user feedback either or both before and after each lesson.

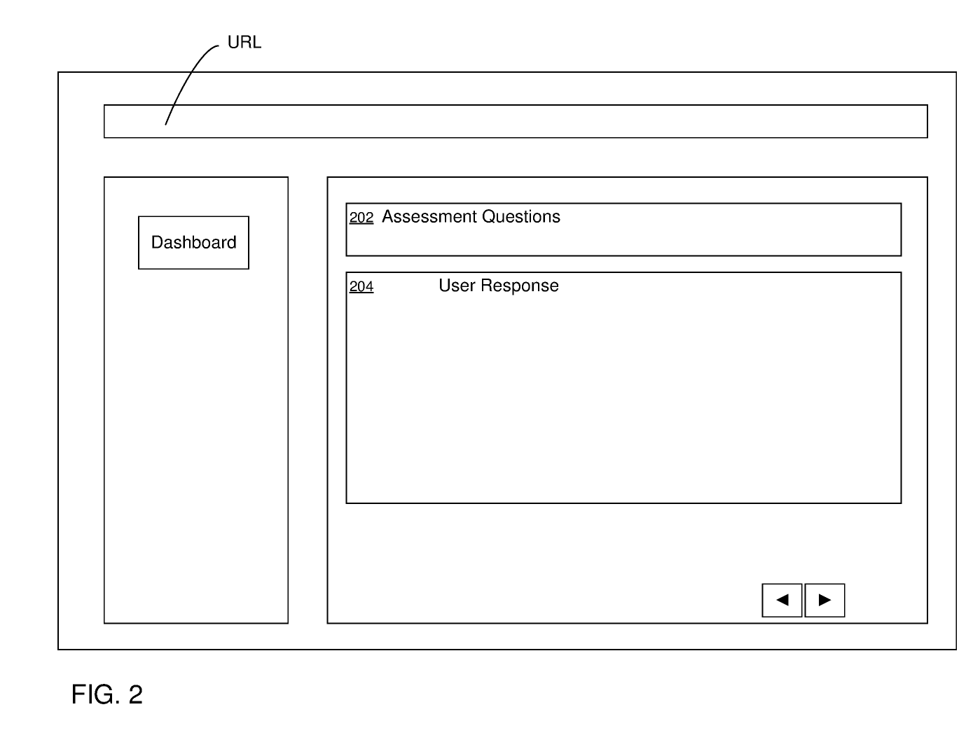

In the exemplary embodiment, the user 118 accesses the Screening Module 102 via an online format. FIG. 2 is a wireframe showing an exemplary embodiment of one screen that may be provided to a user via the Screening Module 102. As shown in FIG. 2, the Screening Module 102 may provide a question prompt or other type of assessment 202 to the user 118. The user 118 provides a response 204 to the question prompt or other assessment. The user response 204 may be in the form of a selection from a series of multiple choice answers, a range or scale of answers, a yes or no answer, a free response, or other types of answers.

In the exemplary embodiment, the Multimedia Library Module 104 stores and organizes video and other media segments. The Multimedia Library Module 104 may include instructional videos, audio clips, graphical instructions or slides, text messages, timers, and other media and data. Video segments may typically range in play length from about 4 seconds to about five minutes, but may also be longer, including 10 minutes, 20 minutes and 30 minutes. Each segment of video or other media or data is related to a specific message, technique, or other need and may be created based on various potential levels of pre-existing knowledge, capabilities or skills of the user. This systematic structure is extremely flexible for highly tailored automated instruction across many different topics. In Personal Automated Fitness Instruction, for example, some segments are exercises, others are between exercise breaks overlaid with announcements of upcoming exercises, including equipment needed, while others are water breaks, position announcements for stretches, stretches themselves, and closing encouragements. Tailored workouts vary based on equipment available to the user, level of difficulty, and user capability, which may be anticipated to change over time, planes of motion, space requirements, relative locations of user's equipment, injured parts of a user's body, if any, variety desired from one workout to another, intensity, break lengths, user goals, upcoming competitive or other events, if any for a user, workout cycles for recovery and progress, and other factors. Other exemplary embodiments show very different uses of the same structure.

In the exemplary embodiment, the Assembler Module 106 receives various inputs. Such inputs may include data received from the user or Calendar Module 110 at the Screening Module 102, or user feedback received at the Delivery Module 108. The Assembler Module 106 is the programming algorithm that draws on data provided by the Screening Module 102, Calendar Module 110, the Multimedia Library Module 104, and/or the Delivery Module 108. The Assembler Module 106 directs the sequencing of video segments, audio clips, text messages, and graphical instructions or slides for delivery to the user.

After the Assembler Module 106 generates a complete instructional sequence, the sequence is stored on the server as a set of instructions for the order and timing of video or other media segments. These media segments may include videos, spacer panels that occupy determined periods of time between certain media segments over which other content may be played, audio clips, text, or other types of multimedia.

In the exemplary embodiment, the Delivery Module 108 may provide video and other media instruction to the user. To display an instructional sequence to the user 118, the Delivery Module 108 receives an ordered list of the specific media segments in sequential order from the Assembler Module 106, and creates a timeline specifying when each media segment will occur in the context of a computed total length of the instructional sequence, or master timeline. The Delivery Module 108 delivers each media segment from the Multimedia Library Module 104 to the user interface. In approximately real time, the Delivery Module 108 monitors the user's progress through both the individual media segment and the master timeline. In case of any discrepancy between the two times (which may occur in the event of an unstable internet connection or if the user manually moves the play head of a video), the progress through the individual media segment is used as the canonical indicator.

In the event that one media segment is by design to be played over another, as in when segments overlap, and a later segment eclipses the end of the earlier one, or when an alternative audio track has been selected by the Assembler Module 106 in lieu of the one normally associated with the video segment, then the Delivery Module 108 determines which media segment supersedes or if they are to be played together. For example, if the two segments are video segments, one will normally eclipse the other. But if one is audio and the other is video with a resident audio track, the resident audio track may be muted in preference for the superseding one.

Using the timeline of media segments, the Delivery Module 108 prepares an array of events that will occur at specified times throughout the master timeline. As soon as the playback progress has passed a scheduled event, the event's functionality fires. Events may also be set to fire upon the occurrence of certain actions, such as when a media item finishes playing, or when the user has interacted with the system in some way, or when the system senses the user's movements no longer reflect anticipated actions corresponding to the particular playback. When an event fires, it triggers some sort of action in the software, such as one or more of the following: removing one media segment from the screen and displaying another; pre-loading an upcoming media segment; requesting feedback from the user; overlaying additional context-appropriate media (such as audio or text) during the playback of an existing media segment; and ending the instructional sequence and moving to another screen.

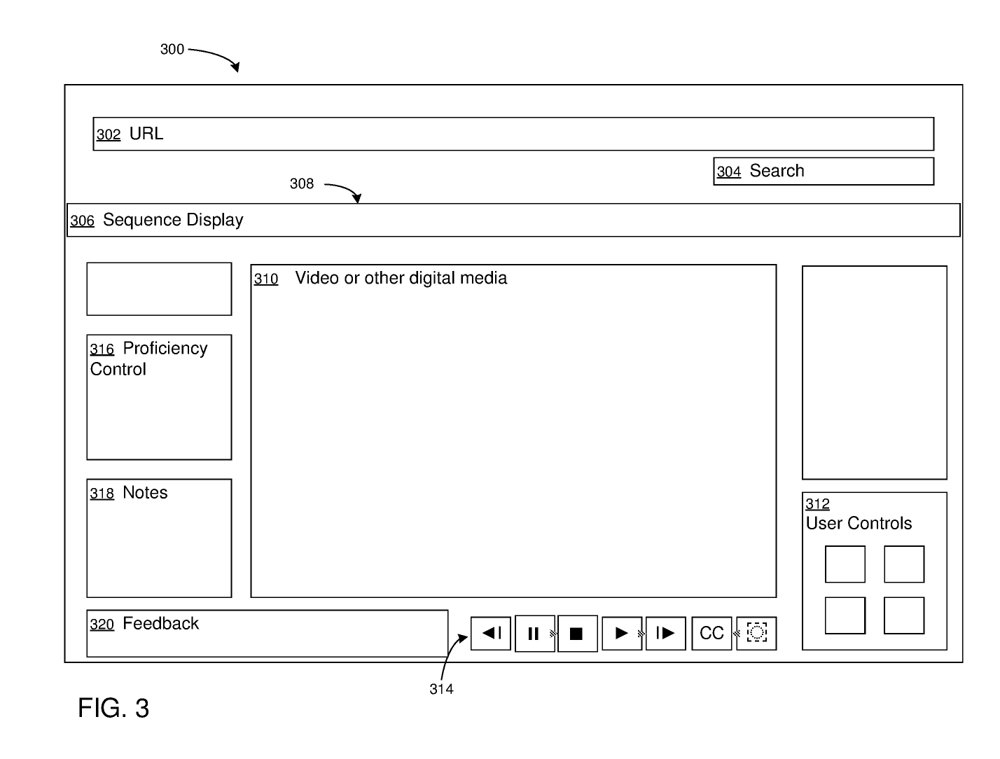

During playback, the Delivery Module 108 may also include on-screen form elements or controls that either or both solicit and accept feedback from the user. FIG. 3 is a wireframe showing an exemplary embodiment of one screen that may be provided to a user via the Delivery Module 108. The screen 300 may display the URL 302 and a search query bar 304. The screen may also display the sequence 306 designated for the user with a marker 308 indicating the user's progress through the sequence 306. The screen may also display the video or playback media 310. The screen may also display one or more user-operated controls 312, 314, 316, 318, 320. These controls 312, 314, 316, 318, 320 are displayed during any appropriate context and allow the client to improve his or her instructional experience by making adjustments in real time to the instructional sequence. Such controls may include one or more of the following: standard video or audio playback controls such as play, pause, volume adjustment, subtitles, full screen, etc.; inputting persistent data or notes associated with the current media segment; increasing or decreasing the requisite proficiency needed by the viewer to fully benefit from the current media segment; moving to alternative, related, or adjacent media segments; providing feedback on current or recently completed media segments; and answering questions posed on screen by one of the media elements, such as video, audio, text, and etcetera. Some or all of the data received via these user feedback mechanisms may be provided to the Screening Module 102, and may then be used by the Assembler Module 106 to adjust a training program.

The Delivery Module 108 guides the user through the totality of the instructional sequence, displaying the different specified media elements in the sequence determined by the Assembler Module 106 and the Delivery Module 108 until the client completes the sequence, modifies it using feedback, or terminates it.

In the exemplary embodiment, the Calendar Module 110 is a scheduler that may determine either or both the sequencing and timing of play of specific instructional sequences. The Calendar Module 110 may direct the Screening Module 102 to direct the Assembler Module 106 to playback specific video or other media based on the date or other day- or time-related data.

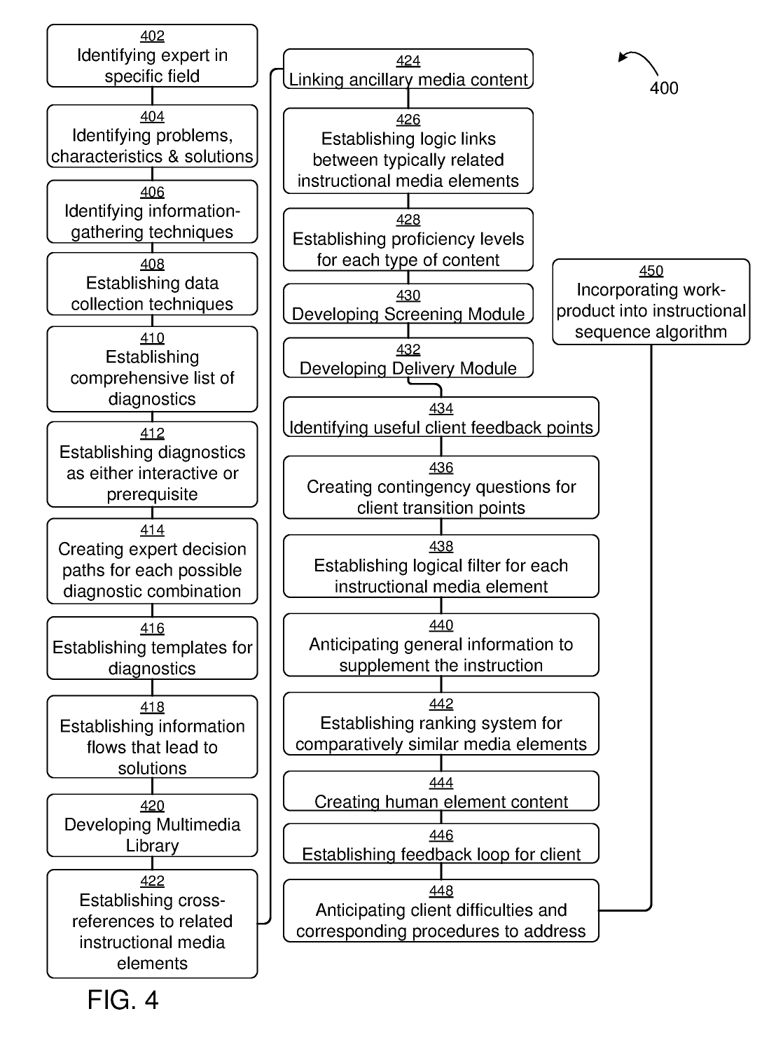

Referring now to FIG. 4, varied types of training sequences may be developed suitable for delivery through a video sequencing system 112. The following is an example of a video sequencing implementation process 400 for development of a program executable by a video sequencing system 112. The steps are given in a sequence for this particular example, but the steps may be varied as appropriate.

Step 402: Identify an expert or experts in a specific field.

Step 404: Have the expert brainstorm the types of issues resolved for clients in the past. Identify the problems, the way each problem is uncovered, the way a client communicates the problems, and the solutions to the problems.

Step 406: Identify information-gathering techniques normally employed by an expert when interviewing a client for the purposes of providing consultancy, guidance, or targeted education.

Step 408: Establish tests, prompts and profile data fields based on the broad knowledge of an expert on the topic that will drive the gathering of information from the client to lead to specifically dictated responses for specific situations encounterable by the expert.

Step 410: Identify a complete list of diagnostic tests used by an expert to identify and troubleshoot the client's situation.

Step 412: For each diagnostic test, analyze whether it can be adapted to an online format. If it can, such testing may be incorporated into an implementation process. If it cannot, such a testing may be conducted prior to entering a video sequencing system, and results captured by an initial intake of the Screening Module 102.

Step 414: Have the expert detail decision points in the consultancy path with a typical client. Specifically, as an expert/client relationship unfolds address what decision points are typically reached, what choices or information are needed from the client, and what are a set of most appropriate responses by the expert in each such situation. Ensure consideration is made for atypical clients.

Step 416: Systematize the normal ways that diagnosis is performed and information is obtained from and by experts in the specific field. For example, templates may be modeled after the timing and stationing of actual small group sessions experience by an expert with past clients. Assessments may be modeled after the system an expert develops to diagnose new clients. The model for taking clients from an impaired state, through correction, to an integrated exercise, and then on to small group training may be based on an experts experience.

Step 418: Identify funnels for information—data about a client that, when coupled with tests or questions that an expert typically asks of a client, will result in a broad array of answers that inevitably lead to different solutions. Expert/client interactions can be recreated in the Screening Module 102, and in interactive client feedback screens in the Delivery Module 108. In this way, the Delivery Module 108 can be coupled with the Screening Module 102 to keep communication open from a client, and to enable a client to redirect the flow of an instructional sequence toward what is important to the client.

Step 420: Using an expert, and information developed in Steps 402 through 418 to build an extensive Multimedia Library Module 104 on a topic. It is advisable to attempt to break content down into very small increments, typically about 4 seconds to 5 minutes in length.

Step 422: Build an extensively cross referenced database for all parts of the Multimedia Library Module 104. Reasonably maximize the links between different pieces of relevant information and each instructional media element to know precisely when it should be used in response to a client need. Provide database links between multimedia content segments. Identify categories of characteristics of the multimedia content that will link it directly to information you will gather from the users in the Screening Module 102, both in their profiles and interactively. Differentiate between instructional media elements that need only be shown once to a user, such as content introducing a subject or content, and instructional media elements that may be shown repeatedly, such as content that addresses the heart of a complex and difficult to grasp subject, or content that guides a user in repetitive, but evolving tasks, or motivational content such as words of praise.

Step 424: Link ancillary media content to the appropriate instructional media elements, such as the timing spacer segments, an audio overlay for seasoned a user, or audio advice about what is coming up next.

Step 426: Establish logical links between various instructional media elements that normally may go together. Also, establish categories of instructional media elements that should not be played together too often and information that is not suited for a particular audience. Relationships between pieces of information will establish programming algorithm used by the Assembler Module 106 to develop candidate instructional media sequences.

Step 428: Establish different levels for each type of content to be delivered on the same subject to users of differing levels of knowledge and sophistication in the specific subject. Some content can be adjusted in a linear fashion by either including it or not, and some content can be adjusted more vertically by showing differing instructional media segments of the same topic adjusted to sophistication of a user, or depending on a user's level of proficiency or experience.

Step 430: Create a Screening Module 102 to gather information needed from a client in accordance with Steps 404 through 428.

Step 432: Employ the Delivery Module 108 to draw the contents from Multimedia Library Module 104 in accordance with user feedback, data, and the instructional media sequences developed by the Assembler Module 106.

Step 434: Identify the most basic and vital feedback that a client can provide in the midst of actual instruction. Incorporate the controls, forms, or interactive screens for the Delivery Module 108 that will enable this information/feedback from a client to be gathered during instruction. Establish feedback mechanisms within a Delivery Module 108 to continue to gather information about client progress and preferences.

Step 436: Create “If Then” contingency questions based on steps 412 through 418, to address when the client reaches a crossroads in a path of instruction. Identify how the information may be obtained from the client, and how the video sequencing system 112 should respond. Modify the Screening Module 102 and Delivery Module 108 accordingly, and add content to the Multimedia Library Module 104 as needed for each such situation.

Step 438: Based on what an expert says is critical for a client to do or know in each situation, establish logical filters for the selection of instruction media elements. Identify whether material filters should be hard filters or ranking filters that establish a scoring system for most relevant instructional media elements. Consideration should be made to distinguish between a) instructional media elements a client will definitely want to see repeatedly, b) instructional media elements a client may or may not want to see again, and c) instructional media elements a client has never seen before, but may need to see. Establish filters to reflect these realities, allocating the most important instructional media elements into an instructional sequence first, and then pulling in instructional media elements that directly address a need or desire of a client. Then other instructional media elements may be ranked for consideration for display based upon relevance to the client's instructional need.

Step 440: If the desire is to develop a system for providing only essential information, and providing it succinctly, then consider designing specific triggers to provide specific answers to questions a client does not initially know enough to ask. Discourse may be set to identify the need of a client, and then the instruction sequence may address that need very directly. An expert can help a client who knows they have a problem, but have difficulty describing it. An expert should know the right questions to ask and tests to run in order to arrive at a solution. This kind of discourse is designed to closely match the way a doctor, a mechanic, a consultant, or any other expert interacts with a client, rather than the way a user interacts with a search engine. Questions or data fields within a startup wizard of the Screening Module 102 user interface are designed to gather information necessary to begin the instructional sequence tailored to the broad characteristics and common or chronic problems of a user, much like an expert would ask in an initial meeting with a client. The Assembler Module 106 contains the algorithm and database links to select the proper instructional media elements from the Multimedia Library Module 104 to address each situation succinctly and directly. However, in evolving expert-to-client relationships such as doctor-to-patient or personal fitness trainer-to-client, continuous client feedback may be necessary from one lesson to another, and even during the course of each lesson. It is common for experts to elicit additional information from a client during an ongoing relationship as the client grows in proficiency, learns more from the expert, recognizes additional issues, encounters a new problem, or modifies a past behavior pattern. It is also common for a client to realize during a course of ongoing instruction that they are or are not ready for higher level or lower level advice or guidance. Delivery Module 108 provides ongoing mid-lesson interactivity through feedback mechanisms such as those in FIG. 3, and more specifically at elements 312, 316, and 320. This interactivity provides information back to the Screening Module 102, which in turn interactively alters the output from Assembler Module 106.

Step 442: Establish a ranking system to identify the best fit instructional media elements when there is not one specific answer to a client query, and then establish tests and feedback mechanisms within the Screening Module 102 and Delivery Module 108 to identify the effectiveness reorder ranking as needed.

Step 444: Optionally, create multimedia segments that inject a human element to the interactions, such as praising the client when they achieve success, if appropriate.

Step 446: Dialog about a client's identified issue continues as the client implements the instructional sequence. The client reports back interactively regarding progress or whether the proposed solution is working. Depending on the feedback, this can be done through the Screening Module 102 or the Delivery Module 108. An automatic decision tree response may be established to address a range of feedback possibilities, such as an increase in the difficulty level for one, some, or all exercises in an instructional sequence, or a return to an earlier point in a sequence. Interactive feedback can be as simple as an unrequested response from the client or as sophisticated as an instructional media element playing a specific pre-recorded question for the client. With each new potential response from the client the expert may have experienced similar situations before and may have them encoded in the algorithm and included in instructional media elements in the Multimedia Library Module 104. The Multimedia Library Module 104 becomes a repository of the collective knowledge and wisdom of the experts in a field, and the system draws on that knowledge and wisdom in a systematic fashion by offering standard tests and questions in response to situations that are common for the experts.

Similar to human interaction, shorthand communication may develop with a client who have seen certain segments before. For example, in Personal Automated Fitness Instruction, a specific exercise segment displayed in Delivery Module 108 would include detailed audio and video instruction the first time it is encountered by the client, but after the client has done this exercise a few times, the audio and video portions of the instruction may be increasingly curtailed or modified until it simply consists of the announcement of the exercise, words of encouragement, and commands of when to start, how much time is left and when to finish. Feedback from the client is permitted in the Screening Module 102 or the Delivery Module 108 if the client wishes to revert to fuller instruction on any or all segments.

Step 448: Anticipate difficulties and create failsafe mechanisms, where appropriate. When a client encounters a difficulty, the video sequencing system 112 may respond with tests to gather more information, or may provide a conduit for client feedback, which in turn can permit the video sequencing system 112 to determine the client's appropriate next step. Such interactions may be directed with a series of “If, then” questions: If the client experiences “this”, then the video sequencing system 112 will respond like “that”. In certain applications, there may need to be a failsafe fallback position, such as when a client has a problem never before encountered by the resident experts or when the standard solutions are not working for the client. The failsafe mechanism may be as simple as advising the client to consult a human expert.

Step 450: Based upon Steps 402 through 448, create the algorithm for the Assembler Module 106.

The foregoing disclosure and description of the invention is illustrative and explanatory thereof, and while directed to the exemplary embodiments of the present invention, other and further embodiments of the invention may be devised without departing from the basic scope thereof. As such, various changes in the details of the exemplary and illustrated construction may be made within the scope of the appended claims without departing from the spirit of the invention. The present invention should only be limited by the following claims and their legal equivalents.

I claim:

1. An interactive instructional media system that interacts with a computer system, comprising:
a Screening Module to collect data from a user and develop training information;
an Assembler Module in communication with the screening module to receive training information developed from the collected data and create an instructional sequence of desirable instructional media based on a programming algorithm;
a Delivery Module to deliver the desirable instructional media to a user according to the instructional sequence; and
a Multimedia Library Module including instructions to manage instructional media, in communication with the Assembler Module to receive request for desirable instructional media and make the desirable instructional media accessible to the Delivery Module.

2. The interactive instructional media system that interacts with a computer system of claim 1, further comprising:
a Calendar Module including instructions to track at least one of a user's available training time and the schedule of a user's past, current, and planned instructional sequence.

3. The interactive instructional media system that interacts with a computer system of claim 1, further comprising:
the Screening Module including instructions to receive data regarding a user through at least one of physiological sensors, diagnostic tests, feedback prompts, profile data fields, and responses to questions.

4. The interactive instructional media system that interacts with a computer system of claim 3, further comprising:
the Assembler Module including instructions to receive data regarding a user from the screening module and adapting a planned instructional sequence.

5. The interactive instructional media system that interacts with a computer system of claim 1, further comprising:
the Screening Module including instructions to sense physiological position of a user.

6. The interactive instructional media system that interacts with a computer system of claim 5, further comprising:
the Screening Module including instructions to sense physiological movement of a user.

7. The interactive instructional media system that interacts with a computer system of claim 5, further comprising:
the Assembler Module including instructions to receive data regarding a user from the screening module and adapt a planned instructional sequence.

8. The interactive instructional media system that interacts with a computer system of claim 5, further comprising:
the Screening Module including instructions to communicate sensed information to the Assembler Module;
the Assembler Module including instructions to conduct at least one of the following, based on the sensed information:
(a) positional dysfunction assessment;
(b) fitness assessment;
(c) massage therapy-related assessment;
(d) physical therapy assessment;
(e) movement impairment assessment;
(f) self-administered myofascial release;
(g) targeted stretching;
(h) exercise form coaching;
(i) exercise intensity coaching;
(j) corrective exercise;
(k) athletic performance enhancement;
(l) posture optimization exercise;
(m) physical positioning pattern adjustment;
(n) injury avoidance exercise; and
(o) health enhancement exercise.

9. The interactive instructional media system that interacts with a computer system of claim 1, further comprising:
the Screening Module including instructions to:
(a) receive user feedback;
(b) update user data based on user feedback; and
(c) effect change to an active instructional sequence.

10. The interactive instructional media system that interacts with a computer system of claim 1, further comprising:
the Screening Module including instructions to capture user data during an active instructional sequence and communicate captured user data to the Assembler Module; and
the Assembler Module including instructions to effect modifications to an active instructional sequence based on captured user data.

11. The interactive instructional media system that interacts with a computer system of claim 1, further comprising:
the Assembler Module including instructions to receive user data captured during an active instructional sequence, and instructions to modify the instructional sequence of desirable instructional media based on the programming algorithm.

12. The interactive instructional media system that interacts with a computer system of claim 1, the Multimedia Library Module further comprising:
short media segments cross referenced to fit into a custom designed structure of a number of potential instructional sequences on a specific complex topic.

13. The interactive instructional media system that interacts with a computer system of claim 1, further comprising:
the Delivery Module including instructions to receive data about the progress of a user through the instructional sequence.

14. The interactive instructional media system that interacts with a computer system of claim 13, further comprising:
the Assembler Module creates a master timeline of the instructional sequence for a user's training; and
the Delivery Module including instructions to monitor the progress of a user through the instructional sequence and comparing it to the master timeline.

15. The interactive instructional media system that interacts with a computer system of claim 1, further comprising:
the Delivery Module including instructions to initiate events according to the instructional sequence.

16. The interactive instructional media system that interacts with a computer system of claim 15, further comprising:
the Delivery Module including instructions to initiate at least one the following types of events:
(a) remove one media segment from a screen and displaying another;
(b) pre-load an upcoming media segment;
(c) facilitate feedback from a user;
(d) consider client feedback during play of the instructional sequence to potentially effect change in the instructional sequence;
(e) overlay an additional media segment on an active media segment; and
(f) end the instructional sequence and moving to another screen.

17. The interactive instructional media system that interacts with a computer system of claim 1, further comprising:
the Delivery Module including instructions to coordinate the interface and potential overlap of individual elements of instructional media within the instructional sequence.

18. A process for developing an automated video sequencing implementation system for interactive training of a specialized subject, comprising:
identifying problems, characteristics & solutions;
establishing data collection techniques;
establishing diagnostics as either interactive or prerequisite;
creating expert decision paths for each possible diagnostic combination;
building a Multimedia Library Module;
establishing proficiency and logical links between at least two instructional media elements;
developing a Screening Module;
developing a Delivery Module;
establishing a feedback loop for a client;
anticipating client difficulties and corresponding procedures to address the client difficulties; and
incorporating work-product from the other steps into an instructional sequence algorithm and an Assembler Module that implements the algorithm.
